(19) United States
(12) Patent Application Publication
(10) Pub. No.: US 2014/0174950 A1
(43) Pub. Date: Jun. 26, 2014

(54) ELECTROCHEMICAL COMPETITION SENSOR

(71) Applicant: NewSouth Innovations Pty Limited, Sydney (AU)

(72) Inventors: Justin Gooding, Queens Park (AU); Guozhen Liu, Shenzhen City (CN)

(73) Assignee: NewSouth Innovations Pty Limited, Sydney (AU)

(21) Appl. No.: 14/193,101

(22) Filed: Feb. 28, 2014

Related U.S. Application Data
(63) Continuation of application No. PCT/AU2012/001032, filed on Aug. 31, 2012.

(30) Foreign Application Priority Data
Sep. 1, 2011 (AU) 2011903531

(51) Int. Cl. G01N 27/327

(52) U.S. Cl. CPC G01N 27/3271
USPC 205/777.5; 204/403.14

(57) ABSTRACT

A method for detecting the presence of an analyte in a sample. The method comprises the steps of: adding to the sample an antibody of the analyte; exposing to the sample a binding moiety capable of becoming associated with the antibody of the analyte, the binding moiety being associated with a redox active species that is bound to an electrode and electrochemically accessible to the electrode; and taking amperometric electrochemical measurements which indicate whether the electrochemistry of the redox active species has been modulated by the binding moiety associating with the antibody of the analyte.

### BACKGROUND OF THE INVENTION

The present invention relates to electrochemical sensors and to methods for detecting the presence of an analyte in a sample.

A number of electrochemical techniques for detecting the presence of an analyte in a sample have been described. These techniques can be classified as catalytic, where reaction of a modified electrode with an analyte produces a new species which can be detected electrochemically, or affinity based, where a binding reaction between an analyte and its binding partner is detected electrochemically.

With affinity based techniques, an enduring challenge has been to detect that the binding event has occurred. Typically, this is achieved using some sort of redox-labelled species that enables differentiation between before and after binding of the analyte. For many affinity based techniques, a redox-labelled species or a species capable of generating a redox active species must be added to the sample at some stage during the analysis in order for the binding event to be electrochemically detectable. It is therefore necessary for a person using the sensor to intervene at a specific point during the analysis, and thus operators of these sensors must be skilled.

International application no. PCT/AU2007/000337 (WO 2007/106936) discloses an affinity based electrochemical sensor capable of detecting the association of an analyte with a binding partner. In one embodiment, the analyte is an antigen and the electrochemical sensor comprises an antibody for the antigen bound to the surface of an electrode via a redox active species. If the antigen is present in a sample to which the sensor is exposed, at least some of the antibody dissociates from the sensor in order to associate with the antigen in the sample. Such disassociation from the sensor affects the electrochemistry of the redox active species and thus is detectable.

Detecting an analyte in a sample using such a sensor relies on the antibody dissociating from the sensor. The sensitivity of such sensors is therefore affected by the amount of the antibody that dissociates from the sensor.

The inventors have unexpectedly discovered that the amount of dissociation of the antibody from the sensors of WO 2007/106936 is more limited when the analyte is a protein, such as glycosylated haemoglobin (HbA1c), rather than a small molecule below 1000 Da, limiting the sensitivity of the sensors for detecting and quantifying such analytes.

HbA1c is a stable minor haemoglobin variant formed by a non-enzymatic reaction of glucose with the N-terminal valine of an adult's haemoglobin 0 chain in the human body. The proportion of haemoglobin in a patient's blood that is glycosylated (i.e. HbA1c) relative to the total haemoglobin in the patient's blood has been found to be indicative of that patient's average blood sugar level over the preceding 2 to 3 months. A direct relationship between HbA1c and diabetic complications has been observed and recent guidelines for the management of diabetes now stress the importance of monitoring HbA1c levels. However, the non-enzymatic origin of HbA1c makes its direct analysis more difficult compared to the diagnosis of other analytes that involve enzymatic reactions.

It would be advantageous to provide an alternative method for detecting analytes such as HbA1c in a sample and sensors for use in detecting such analytes. It would be advantageous to provide a method for detecting analytes such as HbA1c which can be used to quantify the amount of the analyte in the sample.

### SUMMARY OF THE INVENTION

After considerable research, the inventors have now devised a “competitive inhibition assay” to detect analytes such as HbA1c. In a first aspect, the present invention provides a method for detecting the presence of an analyte in a sample. The method comprises the steps of:
adding to the sample an antibody of the analyte;
exposing to the sample a binding moiety capable of associating with the antibody of the analyte, the binding moiety being associated with a redox active species that is bound to an electrode and electrochemically accessible to the electrode; and
taking amperometric electrochemical measurements which indicate whether the electrochemistry of the redox active species has been modulated by the binding moiety associating with the antibody of the analyte.

In contrast to the method of WO 2007/106936, the “competitive inhibition assay” of the present invention does not require an antibody (for the analyte) bound to the surface of an electrode to dissociate from the sensor in order to detect the presence of the analyte. In the “competitive inhibition assay” of the present invention, the antibody of the analyte added to the sample can bind to either the analyte in the sample (if the sample does contain the analyte) or to the binding moiety associated with the redox active species. By comparing the amount of the antibody added to the sample with the amount of antibody which associates with the binding moiety (and is thus detectable by taking amperometric electrochemical measurements), an indication of the presence and amount of the analyte in the sample can be obtained.

The inventors have found that the method of the present invention can be used to detect and quantify non-antibody proteins, such as HbA1c, in a sample with greater sensitivity and accuracy than the methods disclosed in WO 2007/106939.

The method of the present invention exploits the changes in electrochemistry of the redox active species which occur when the binding moiety associates with the antibody of the analyte. As the redox active species is bound to and electrochemically accessible to the electrode the changes in its electrochemistry occur (and are detectable) without the need to add additional redox active species (or species capable of reacting to generate a redox active species) during analysis of a sample.

The amperometric electrochemical measurements can advantageously be taken at the time the sample is exposed to the binding moiety, that is, at the same time that the binding moiety associates with the antibody of the analyte (i.e. association of the binding moiety with the antibody is electrochemically contemporaneously detected), which can significantly simplify the detection process such that any person could test the sample.

In some embodiments, the electrochemical measurements can be used to quantify the amount of the antibody of the analyte which associates with the binding moiety. The method may also, in some embodiments, comprise the further step of calculating the amount of the analyte in the sample based on the amount of the antibody of the analyte which associates with the binding moiety.

In some embodiments, the analyte is a protein, e.g. HbA1c.

In some embodiments, the analyte is HbA1c. In such embodiments, the binding moiety may, for example, comprise (or be) an epitope for an antibody of HbA1c (e.g. a glycosylated polypeptide, such as N-glycosylated-Val-His-Leu-Thr-Pro).

As discussed above, the proportion of HbA1c relative to the total haemoglobin in a patient's blood is indicative of that patient's average blood sugar level over the preceding 2 to 3 months. Thus, in some embodiments, the method of the first aspect of the present invention can be used to determine blood glucose levels of a patient over an extended period of time in order to provide an indication of the patient's blood glucose levels over the extended period and thereby assist in the management of diabetes.

In a second aspect, the present invention provides a method for determining blood glucose levels in a patient. The method comprises the steps of:
adding to a sample of the patient's blood an antibody of HbA1c;
exposing to the sample a binding moiety capable of associating with the antibody of Hb1Ac, the binding moiety being associated with a redox active species that is bound to an electrode and electrochemically accessible to the electrode; and
taking amperometric electrochemical measurements which indicate whether the electrochemistry of the redox active species has been modulated by the binding moiety associating with the antibody of HbA1c.

In a third aspect, the present invention provides an amperometric electrochemical sensor for detecting an analyte. The sensor comprises:
an electrode;
a redox active species that is electrochemically accessible to the electrode; and
a binding moiety capable of associating with an antibody of the analyte;
   whereby association of the binding moiety with the antibody of the analyte affects the electrochemistry of the redox active species.

The electrochemical sensor of the present invention is specifically adapted for performing the methods of the present invention.

In some embodiments, the analyte is HbA1c and the binding moiety is or comprises an epitope for an antibody of HbA1c (e.g. a glycosylated polypeptide such as N-glycosylated-Val-His-Leu-Thr-Pro).

In a fourth aspect, the present invention provides a kit for detecting the presence of an analyte in a sample, the kit comprising the electrochemical sensor of the third aspect and a container comprising an antibody of the analyte.

In a fifth aspect, the present invention provides a method for detecting the presence of an analyte in a sample. The method comprises the steps of:
adding to the sample an antibody of the analyte;
exposing to the sample the electrochemical sensor of the third aspect; and
taking amperometric electrochemical measurements which indicate whether the electrochemistry of the redox active species has been modulated by the binding moiety associating with the antibody of the analyte.

In a sixth aspect, the present invention provides a method for determining blood glucose levels in a patient. The method comprises the steps of:
adding to a sample of the patient's blood an antibody of HbA1c;
exposing to the sample the electrochemical sensor of the third aspect; and
taking amperometric electrochemical measurements which indicate whether the electrochemistry of the redox active species has been modulated by the binding moiety associating with the antibody of the HbA1c.

As mentioned above, it is not necessary for a user to perform further steps when testing a sample for the analyte. Accordingly, in some embodiments of the methods of the present invention, the method consists essentially of, or consists only of, the steps referred to above.

### BRIEF DESCRIPTION OF THE DRAWINGS

In the following detailed description, the following Figures are referred to, in which:

FIG. 1 shows a schematic representation illustrating an embodiment of the “competitive inhibition assay” of the present invention, as well as the molecular structure of N-glycosylated VHLTP, an exemplary binding moiety;

FIG. 2 shows a schematic representation of an embodiment of the electrochemical sensor of the present invention; and

FIG. 3 shows exemplary square wave voltammograms (SWV) for the electrode of an electrochemical sensor comprising an electrode having a redox active species bound to the electrode via a molecular wire after the attachment of: (a) N-glycosylated VHLTP (an epitope for the antibody of HbA1c) to the redox active species; and (b) anti-HbA1c IgG (the antibody of HbA1c) to the epitope.

### DETAILED DESCRIPTION

The present invention provides a method for detecting the presence of an analyte in a sample. The method comprises the steps of:
adding to the sample an antibody of the analyte;
exposing to the sample a binding moiety capable of associating with the antibody of the analyte, the binding moiety being associated with a redox active species that is bound to an electrode and electrochemically accessible to the electrode; and
taking amperometric electrochemical measurements of the redox active species.

The amperometric electrochemical measurements indicate whether the electrochemistry of the redox active species has been modulated by the binding moiety associating with the antibody of the analyte.

The method of the present invention provides a “competitive inhibition assay”, in which any analyte present in the sample competes with the binding moiety for the antibody that was added to the sample. By comparing the amount of antibody added to the sample with the amount of antibody which associates with the binding moiety (and is thus detectable by taking amperometric electrochemical measurements), an indication of the presence and amount of the analyte present in the sample can be obtained.

The methods of the present invention are based on detecting and measuring the modulation of amperometric signals of a redox active species bound to an electrode. When the binding moiety is exposed to a sample that contains an antibody with which the binding moiety can associate, the antibody can bind to the binding moiety (and to any analyte in the sample). Without wishing to be bound by theory, the inventors believe that the electrochemistry of the redox active species associated with the binding moiety is suppressed when the antibody binds to the binding moiety because ions in the sample are restricted from interacting with the redox active species as the relatively large antibody enfolds the redox active species and effectively “shields” the redox active species from ions in the sample. This suppression is detectable using electrochemical techniques and may be quantified. Thus, transduction of the affinity based recognition event (i.e. the antibody attaching to the binding moiety) is achieved simply by exposing the sensor to the sample and passing an electrical current through the electrode.

The association of the antibody of the analyte with the binding moiety affects the electrochemistry of the redox active species, and thus alters the ability of the electrode to oxidise and reduce the redox active species. For example, upon sweeping the potential of the electrode progressively more positive (cyclic voltammetry), or stepping the potential progressively more positive (square wave voltammetry), the redox active species becomes more susceptible to oxidation and eventually oxidises (e.g. a ferrocene moiety will be oxidised to the ferrocinium ion). In the voltammograms, this is represented by an increase in anodic current as electrons transfer to the electrode. Sweeping the potential back more negatively will result in the reduction of the redox active species (e.g. a ferrocinium ion will be reduced to the ferrocene moiety) as electrons transfer from the electrode to the redox active species. The association of the binding moiety with the antibody of the analyte will affect the ability of the electron transfer to occur, increasing or diminishing the peaks observed in the voltammograms.

The “competitive inhibition assay” detects binding of the antibody to the binding moiety. Thus, the “competitive inhibition assay” does not rely on an antibody of the analyte dissociating from the binding moiety to detect an analyte in a sample.

The “competitive inhibition assay” of the present invention can be used to determine the presence and amount of many analytes in a sample (provided that an antibody of the analyte can be accessed). Exemplary analytes include: proteins such as HbA1c, prostate specific antigen, tau, ICAm-1, VEGF, interleukins, tissue necrosis factors, lipoproteins, HER2, human chorionic gonadotropin, cancer antigen-125, kinases, pathogens and protozoa such as cryptosporium parvum, giardia, staphylococcus aureus, vibrio cholerae, and viruses such as rotavirus, enterovirus, norovirus and hepatitis A.

As used herein, a reference to exposing a binding moiety to a sample refers to exposing the binding moiety (of a sensor) to the sample in a manner that would permit the binding moiety to associate with the antibody of an analyte present in the sample. Typically, the binding moiety is bound to the redox active species that is bound to the electrode. Typically, the binding moiety is exposed to the sample by placing at least part of the electrode in the sample, thereby enabling the binding moiety to associate with the antibody of analyte present in the sample.

In the “competitive inhibition assay”, the antibody of the analyte can be added to the sample at the same time that the sensor is exposed to the sample. Alternatively, the antibody of the analyte can be added to the sample before or after the sensor is exposed to the sample.

The methods of the present invention will now be described in further detail with respect to its second aspect, which relates to a method for determining blood glucose levels in a patient. The patient's blood glucose levels are determined by detecting the amount of the protein HbA1c in a sample of the patient's blood. As discussed above, the proportion of HbA1c to the patient's total haemoglobin (Hb) is a good indication of the patient's average blood glucose levels over the preceding 2-3 months. The method of the second aspect comprises the steps of:
adding to a sample of the patient's blood an antibody of HbA1c;
exposing to the sample a binding moiety capable of associating with the antibody of Hb1Ac, the binding moiety being associated with a redox active species that is bound to an electrode and electrochemically accessible to the electrode; and
taking amperometric electrochemical measurements which indicate whether the electrochemistry of the redox active species has been modulated by the binding moiety associating with the antibody of HbA1c.

Typically, as part of determining a patient's average blood glucose levels, the electrochemical measurements will be used to quantify the amount of the antibody of HbA1c which associates with the binding moiety of the sensor. From this, a further step may be conducted in which the amount of HbA1c in the sample is calculated based on the amount of the antibody of HbA1c that associates with the binding moiety.

Typically, the method is repeated at predetermined time intervals (e.g. every 2 to 3 months) in order to monitor the patient's blood glucose levels over time. In this manner, any changes in the patient's blood glucose levels can be carefully analysed in order to ascertain whether the patient's treatment regimen is appropriate.

In order to provide an additional degree of specificity, in some embodiments, the binding moiety is or comprises an epitope for an antibody of HbA1c. One suitable class of epitopes are or comprise glycosylated polypeptides, for example, N-glycosylated-Val-His-Leu-Thr-Pro.

In some embodiments of the present invention, the competitive inhibition assay is adapted for detecting HbA1c using a N-glycosylated pentapeptide as a HbA1c analogon. Using the methods described below, an immunosensor having a mixed layer of molecular wire and oligo(ethylene glycol) is provided attached to a glassy carbon electrode. A redox active species in the form of ferrocene dimethylamine is attached to the end of the molecular wire. A binding moiety in the form of an epitope (a structural feature the antibody of the analyte selectively recognises) is attached to the ferrocene dimethylamine to give the final immunosensor interface. In some embodiments, the epitope employed is N-glycosylated-VHLTP. The molecular wire, having the ferrocene moiety bonded to one end and the electrode bonded to its other end, transfers electrons rapidly and efficiently between the ferrocene moiety and the electrode, thus enabling transduction of the biorecognition event to be transferred to the electrode. Transduction in this system is based on the amperometric signal of the surface bound ferrocene moiety being attenuated when the antibody binds to the epitope due to the immersion of the ferrocene into a protein environment.

In some embodiments, a sensor of the present invention may comprise a conductive nanoparticle (e.g. a gold nanoparticle) as a species that is a conduit for electron movement. In such embodiments, the sensor has an electrode (e.g. a glassy carbon electrode or a gold electrode) that is coated with a protective layer (e.g. a layer comprising molecules of oligo(ethylene glycol) and 4-thiophenyl). Conductive nanoparticles are bonded to the protective layer (e.g. by reacting with the thiol group of a surface bound 4-thiophenyl) and redox active species are attached to the nanoparticles. A binding moiety is attached to the redox active species to give the final immunosensor interface. Conductive nanoparticles attached to the ends of otherwise passivating protective layers on electrodes have been found to provide channels through which electron transfer can proceed as though the protective layer was not present. The conductive nanoparticle is therefore capable of rapidly and efficiently transferring electrons between the redox active species and the electrode, thus enabling transduction of the biorecognition event to be transferred to the electrode.

The use of a conductive nanoparticle as a species that is a conduit for electron movement has advantages compared to some molecular wires and carbon nanotubes. Some molecular wires or carbon nanotubes can be unstable in air, difficult to synthesise in large quantities and/or not very durable. Further, some carbon nanotubes will not always reliably react in the necessary manner to immobilise them on the surface of the sensor. Conductive nanoparticles are, in general, very stable and durable and will react in a predictable manner. Hence, sensors which utilise conductive nanoparticles as species that are conduits for electron movement may be more durable and longer lasting than sensors that utilise other species as conduits for electron movement.

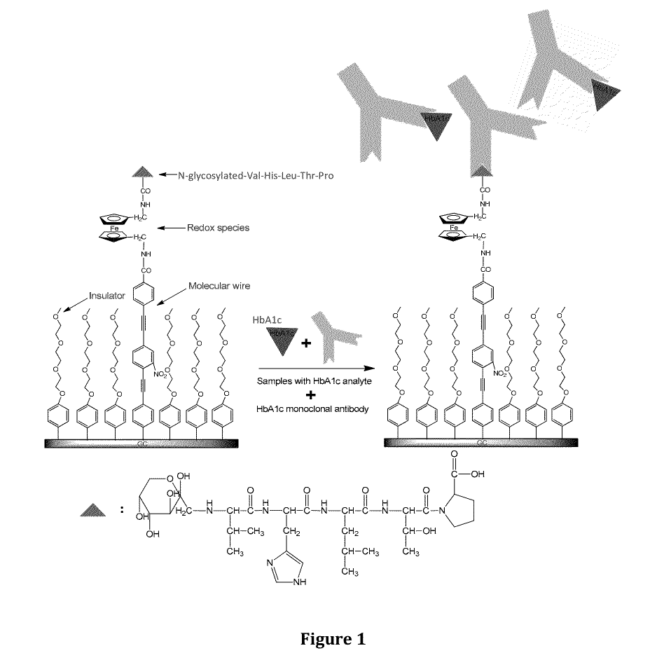

A schematic drawing depicting the competitive inhibition assay being used for the detection of HbA1c is shown in FIG. 1. The left hand side of FIG. 1 depicts a sensor for use in the competitive inhibition assay. The right hand side of FIG. 1 depicts the sensor after the antibody for HbA1c (HbA1c monoclonal antibody) has been added to the sample and the sensor exposed to the sample. As can be seen, the HbA1c monoclonal antibody has bound to the HbA1c in the sample as well as to the binding moiety on the sensor. It should be noted that the antibody in these representations is depicted for clarity as being only slightly larger than the binding moiety (N-glycosylated-VHLTP). The antibody would typically be many times larger than the binding moiety.

It is also possible to quantify the amount of analyte present in a sample using the methods of the present invention. This can be achieved by calibrating the electrode response to the proportion of HbA1c in a blood sample relative to the proportion of Hb in the same sample. Interaction between the binding moiety and the antibody results in the antibody binding to the binding moiety. As discussed above, the formed bulky structure of the binding moiety/antibody biomolecular pair perturbs the electrical communication between the redox active species and ions in the sample, which modulates (inhibits) the resulting amperometric signal. The extent of the electrode coverage by the antibody (i.e. the proportion of redox active species that are inhibited) is proportional to the concentration of available antibody in the sample (i.e. antibody that has not already bound to the analyte) as well as to the time for which the electrode is exposed to the sample. Thus, if the duration of exposure to the sample is fixed, the decrease in the electrode amperometric response correlates with the concentration of available antibody in the sample.

The present invention also provides an electrochemical sensor adapted to perform the methods of the present invention. The amperometric electrochemical sensor for detecting an analyte comprises:
an electrode;
a redox active species that is electrochemically accessible to the electrode; and
a binding moiety capable of associating with an antibody of the analyte;
   whereby association of the binding moiety with the antibody of the analyte affects the electrochemistry of the redox active species.

In some embodiments, the binding moiety is capable of becoming bound to the antibody of the analyte.

In some embodiments, the binding moiety is at least part of an antigen.

In some embodiments, the binding moiety comprises (or consists of) an epitope for the antibody of the analyte.

In some embodiments, the binding moiety is bound to the redox active species.

In some embodiments, the sensor further comprises blocking agents (e.g. polyethylene glycol (PEG) or oligo(ethylene glycol) (OEG) moieties) bound to the surface of the electrode. These blocking agents prevent non-specific interactions from occurring at the electrode surface by masking the electrode surface. By preventing such interactions, the sensitivity and reliability of the electrochemical sensor of the present invention may be greatly increased.

In some embodiments, the redox active species is bound to the electrode, for example, via a species that is a conduit for electron movement (e.g. a molecular wire or a nanotube, both of which are rigid species that efficiently transfer electrons).

In some embodiments, the redox active species is bound to a conductive nanoparticle that is bound to a protective layer covering the electrode. Conductive nanoparticles attached to otherwise passivating protective layers on electrodes have been found to provide channels through which electron transfer can proceed as though the protective layer were not present. The conductive nanoparticle is therefore capable of rapidly and efficiently transferring electrons between the redox active species and the electrode, thus enabling transduction of the biorecognition event to be transferred to the electrode.

In some embodiments, the conductive nanoparticle is a metallic nanoparticle (e.g. a gold nanoparticle). In some embodiments, the conductive nanoparticle has a diameter in the nanometer range (i.e. about 1 nm to about 1000 nm). In some embodiments, the conductive nanoparticle has a diameter of from about 2 nm to about 50 nm, for example from about 10 nm to about 50 nm or from about 52 nm to about 25 nm.

The protective layer may, for example, be a self-assembled layer comprising molecules of oligo(ethylene glycol) or 4-thiophenyl.

In some embodiments, the redox active species is a ferrocene moiety.

In some embodiments, the electrode is a glassy carbon electrode or a gold electrode.

In some embodiments, the sensor further comprises a detector capable of detecting changes in the electrochemistry of the redox active species as a result of the association of the binding moiety with the analyte. The change in the electrochemistry of the redox active species is typically detected by analysing changes in the ability of the electrode to oxidise and reduce the redox active species as the potential of the electrode is scanned anodically and cathodically respectively.

In some embodiments, the sensor further comprises an electrical power source. In some embodiments, the sensor further comprises a display for displaying electrochemical readings from the electrode.

The sensors of the present invention will typically include a large number of redox active species and binding moieties distributed on the surface of the electrode.

The components of the electrochemical sensors of the present invention will now be described in further detail.

### Electrodes

Any electrode may be used in the electrochemical sensor of the present invention. Electrodes suitable for use in the sensors of the present invention include, for example, carbon paste electrodes, screen-printed carbon electrodes, glassy carbon (GC) electrodes, gold electrodes, platinum electrodes, carbon nanotube electrodes, indium tin oxide electrodes, silicon electrodes, aluminium electrodes, copper electrodes, etc.

Typically, GC electrodes are used because they are inexpensive and can be mass produced. They are also very dense, chemically inert, electrically conductive and have a relatively well defined structure. GC electrodes can also be modified by the formation of stable self-assembled monolayers (SAMs) or self-assembled layers (SALs) on the surface of the electrode using techniques described in the art. Modified GC electrodes have a large potential window, which is advantageous because it allows many different types of molecules to be investigated electrochemically (some molecules are not stable at too negative or too positive potentials).

### Redox Active Species

The redox active species may be any species that can be electrochemically interrogated. The redox active species must be electrochemically accessible to the electrode in order for electrons to be transferred between the species and the electrode, so that changes in the redox state of the redox active species can be detected by changes in the electrical current through the electrode.

In some embodiments, the binding moiety may itself contain a redox active species. In such embodiments, the sensor need not have an additional redox active centre (i.e. the redox active species is part of the binding moiety).

General examples of suitable redox active species include organometallic complexes, metal ion complexes, organic redox active molecules, metal ions and nanoparticles containing a redox active centre.

The redox active species may be chemically bound to the distal end of a species that is a conduit for electron movement (as will be described below), and therefore bound, via the species that is a conduit for electron movement, to the electrode. Alternatively (or in addition), the redox active species may be chemically bound to a conductive nanoparticle that is bound to a protective layer covering the electrode.

In the sensors of the present invention, the redox active species and the binding moiety are typically situated sufficiently proximate to each other so that the association of the binding moiety with the antibody of the analyte affects the electrochemistry of the redox active species. For example, the redox active species may be directly bound to the binding moiety. Alternatively, the redox active species may be bound to the binding moiety via a short (e.g. C₁₋₁₀) alkyl chain, or the like. In some embodiments, the redox active species is bound to the binding moiety via a C₁₋₅ alkyl chain.

The redox active species in the sensor of the present invention is typically the redox active centre in a redox active compound, where the redox active compound is capable of undergoing chemical reactions in order to bind the redox active centre to other components of the sensor. Compounds that may be used typically have one or more functional groups that enable them to bind to other components of the sensor (e.g. the binding moiety or species that is a conduit for electron movement) via chemical bonds. Preferred redox active compounds that may be used possess amine functional groups, which facilitate the attachment of the compound to other components of the sensor. For example, ferrocenedimethylamine and flavin adenine dinucleotide are redox active compounds that can react with, and be covalently attached to, other compounds via amide coupling(s). The redox active centre in ferrocenedimethylamine is referred to below as the “ferrocene moiety”.

Specific examples of compounds that may be used to incorporate the redox active species in the sensor of the present invention include ferrocenedimethylamine, 1,5-diaminonaphthalene, pyrrolo quinoline quinone, 2,3,5,6-tetramethyl-1,4-phenylenediamine, flavin adenine dinucleotide, ethidium, ruthenium(NH₃)₄pyridine²⁺, ruthenium(2,2′bipyridyl)₂(dipyrido[3,2:α-2′,3′:γ]phenazine)²⁺, ruthenium((5-glutaric acid monohydride)-1,10-phenanthroline)₂(dipyrido[3,2:α-2′,3′:γ]phenazine)²⁺, ruthenium(2,2′-bipyridyl)₄(imidazole)(2-amino-2-deoxyuridine), rhodium(9,10-phenanthrolinequinone diimine)₂((5-glutaric acid monohydride)-1,10-phenanthroline)³⁺, rhodium(2,2′-bipyridyl)₂(5,6-chrysenequinone diimine)³⁺, osmium(1,10-phenanthroline)₂(dipyrido[3,2:α-2′,3′:γ]phenazine)²⁺, 5,10,12,20-tretrakis(1-methyl-4-)porphyrin, 5,10,12,20-tretrakis(-2-pyridinio)porphyrin, and 3-nitrobenzothiazolo[3,2-α]quinoliumchloride.

### Electrochemically Accessible to the Electrode

As discussed above, the redox active species must be electrochemically accessible to the electrode in order for changes in the redox state of the species to be detected by changes in the electrical current in the electrode. The redox active species may be held in a position in which it is electrochemically accessible to the electrode by any means, for example, by chemical bonding or by absorption. Typically, the redox active species is bound to the electrode via a species that is a conduit for electron movement. The species that is a conduit for electron movement provides a means by which electrons can move between the redox active species and the electrode, for example by tunneling or electron transport.

Examples of species that can be conduits for electron movement include molecular wires, nanotubes (such as single walled carbon nanotubes), conductive nanoparticles and norbornylogous bridges. Molecules that may be used to form a conduit for electron movement between the electrode and the redox active species include aliphatic alkanes, oligo(phenylene vinylene), oligo(phenylene ethynylene), polyacetylene, polythiophene, Carotenoids and Li₂Mo₆Se₆.

In embodiments where the conduits for electron movement are molecular wires or nanotubes, the species are substantially linear and can, in some embodiments, be bonded to the surface of the electrode at one of its ends. The other ends may be bonded to the redox active species.

In embodiments where the conduits for electron movement are a conductive nanoparticles that are bound to a protective layer covering the electrode, the sensor is typically prepared using conductive nanoparticles having surface groups capable of reacting with the redox active species and with groups forming part of the protective layer covering the electrode, thereby bonding the redox active species to the electrode via the conductive particle.

The ends of a compound that can be used to create the species that is a conduit for electron movement in a sensor of the present invention preferably have functional groups (e.g. carboxylic acid functional groups) that are capable of reacting with another compound. Thus, when the compound is bonded to the surface of an electrode via a first reaction (e.g. a coupling reaction), a redox active species possessing an appropriate functional group (e.g. an amine functional group) may be bonded to the compound (and therefore to the electrode) via a second reaction such that the electrode and redox active species are joined by the species that is a conduit for electron movement.

In some embodiments, a combination of one or more different types of species that are conduits for electron movement may be used in the sensor.

### Binding Moiety

The binding moiety in the present invention is capable of associating with an antibody of the analyte, which results in the electrochemistry of the redox active species being affected. Typically, the association of the binding moiety and antibody of the analyte is affinity based, that is, the binding moiety and antibody have an affinity for binding to each other. In such cases, the binding typically occurs as a result of the binding moiety having the correct spatial conformation for the antibody to bind whereupon a combination of intramolecular bonding forces, such as hydrogen bonding, van der Waals forces and other electrostatic forces, operate cooperatively to strongly bind the antibody and binding moiety together.

The present invention may be used to detect the presence of an antibody of any analyte, provided that the binding moiety is capable of associating with the antibody (e.g. because of an affinity based binding event).

In addition to antibody/antigen binding events, other affinity based binding events include those between lectins and sugars, peptides and proteins, macrocyclic ligands and organic molecules. The present invention can therefore be used to transduce these binding events in order to detect such analytes in a sample. For example, the present invention can be used to detect lectins or sugars in a sample, peptides or proteins in a sample, or macrocyclic ligands or organic molecules in a sample. The present invention can, for example, be used to detect the antibody in any of the following antibody/antigen pairs: biotin/antibiotin, endosulfan/antiendosulfan, pollutants such as 2,4-dinitrophenol(DNP)/antiDNP, HbA1c/anti-HbA1c IgG, bisphenol A/antibisphenol A antibodies, 2,3,7,8-tetrachlorodibenzofuran (TCBF)/antiTCBF, 2,3,7,8-tetrachloro-dibenzo-p-dioxin (TCDD)/AntiTCDD, 3,3′,4,4′,5,5′-hexachlorodibiphenyl (HCBP)/antiHCBP, drugs (theophylline/antitheophylline), bactericides (enrofloxacin/antienrofloxacin) and pesticides such as atrazine/antiatrazine, and parathion/antiparathion.

The binding moiety is preferably at least part of an antigen to which the antibody is capable of binding (e.g. at least a part of the analyte molecule).

The binding moiety may, for example, comprise an epitope of the analyte. In some embodiments, the binding moiety is the epitope. In such embodiments, the epitope can provide a very high degree of selectivity for the relevant antibody, and the sensor is less susceptible to interference by other species which may be present in the sample to be tested.

In some embodiments, the epitope may be chemically synthesized. That is, the binding moiety may be a chemical analogue of an epitope of the analyte. Alternatively, the epitope may be isolated from the analyte.

The inventors previously believed that the binding moiety should preferably be a relatively small species so as not to suppress the electrochemistry of the redox active species when the binding moiety is not bound to the antibody. However, the inventors have surprisingly found that relatively large species, such as peptides containing 5 to 10 amino acids can be used as the binding moiety without suppressing the electrochemistry of the redox active species. Thus, in some embodiments, the binding moiety comprises a sequence of amino acids.

The inventors have found that a suitable binding moiety for detecting HbA1c analyte is a N-glycosylated pentapeptide such as N-glycosylated-Val-His-Leu-Thr-Pro.

The binding moiety is typically situated sufficiently proximate to the redox active species so that the binding of the antibody to the binding moiety affects the electrochemistry of the redox active species. The binding moiety may, for example, be bonded directly to the redox active species. Alternatively, the binding moiety may be bonded to the redox active species via a short length alkyl chain (e.g. C₁₋₁₀) or the like. As noted above, in some embodiments, the redox active species may be part of the binding moiety itself.

### Formation of Electrochemical Sensors

The chemistry and processes relating to the formation of self assembled monolayers (SAMs) and self assembled layers (SALs) on the surface of an electrode is well-known.

A process for forming on a GC electrode a SAM or SAL comprising a redox active species and a binding moiety will now be described to illustrate how a sensor in accordance with an embodiment of the present invention can be prepared. SAMs and SALs may be formed on the surface of other types of electrode using techniques well known in the art.

Using techniques known in the art, a species that is a conduit for electron movement can be bound to the surface of a GC electrode by the electrochemical reduction at the electrode of an aryl diazonium salt that is substituted with the species. A negative potential at the electrode causes the diazonium salt to reduce (with the release of N₂), which produces a radical on the aryl ring of the diazonium salt. Radical attack on the GC electrode surface results in the formation of a C—C bond between the electrode and the aryl ring to give a stable SAM or SAL.

When the species is bound to the 4-position of the aryl group, the species projects outwards in an approximately normal conformation from the surface of the electrode in the resultant SAM or SAL. Alternatively, a GC electrode may be modified with an aryl diazonium salt having a functional group capable of undergoing subsequent reactions at the 4-position of the aryl group. A species that is a conduit for electron movement may then be bonded to the 4-position of the aryl group (and hence the electrode) in a reaction subsequent to the reaction in which the aryl diazonium salt is reduced onto the surface of the electrode.

Typically, the SAM or SAL formed on the surface of the GC electrode includes a mixture of species that are a conduit for electron movement and one or more kinds of blocking agents (sometimes referred to below as “insulators”). The blocking agents effectively “insulate” the remainder of the surface of the electrode by preventing any species which may be present in the sample to be tested from adsorbing on to the electrode. The risk of such interactions interfering with the detection of the analyte in the sample is therefore lessened, which gives a more reliable sensor.

In some embodiments, the non-specific adsorption of molecules on the surface of the electrode may be minimized by masking the surface of the electrode with blocking agents such as bovine serum albumin or a hydrophilic layer formed by a compound such as polyethylene glycol (PEG) or oligo(ethylene glycol) (OEG). PEG comprises short chain ethylene oxide polymers that may be bound to the 4-position of some of the aryl groups attached to the surface of the GC electrode.

The proportion of species that are a conduit for electron movement to insulator on the SAM or SAL may, for example, be about 1:1, 1:10, 1:20, 1:50, 1:100 or 1:1000.

The distal end of the species that is a conduit for electron movement may be provided with a functional group (e.g. a carboxylic acid functional group) that is capable of reacting with another compound. Thus, when the species that is a conduit for electron movement has been bonded to the surface of the GC electrode to form a SAM or SAL as described above, a compound comprising a redox active species and possessing an appropriate functional group (e.g. an amine functional group in the case of ferrocenedimethylamine or flavin adenine dinucleotide) may be bonded to the distal end of the species (and therefore to the electrode) via a coupling reaction. Other functional groups could, of course, be utilized to enable the species that is a conduit for electron movement and a compound containing the redox active species to be joined using standard chemical techniques.

The binding moiety may then be bound to the redox active species. For example, one of the amine groups of ferrocenedimethylamine may be used to couple the ferrocene moiety to the distal end of the species that is a conduit for electron movement, and the other amine group may be used to couple the binding moiety to the ferrocene moiety. In these circumstances, the ferrocene moiety joins and bridges the species that is a conduit for electron movement and the binding moiety.

The binding moiety may alternatively be bonded to the redox active species via a short length alkyl chain, or the like.

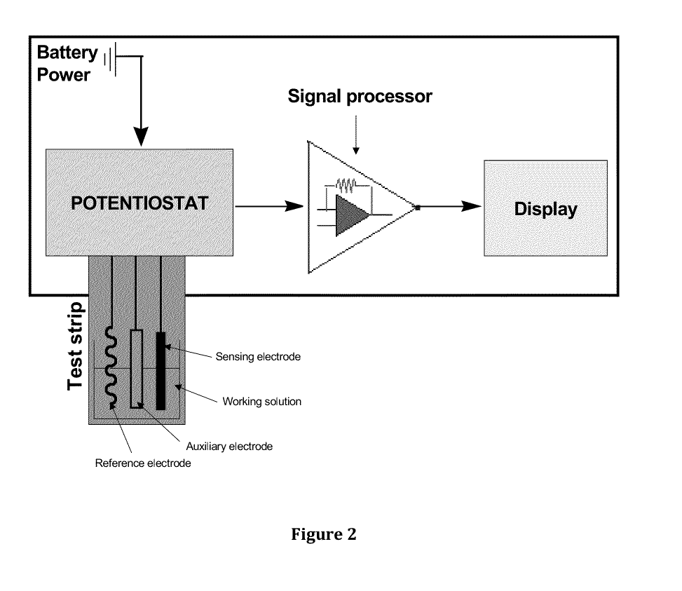

The amperometric sensors of the present invention will typically include additional components that enable the results of the sample analysis to be viewed by the operator. For example, the sensor would typically include a source of electricity (such as a battery), a potentiostat, a signal processor and a display. The electrode having the SAM or SAL described above would typically be provided as part of a test strip comprising the electrode having the SAM described above, a reference electrode and an auxiliary electrode. A schematic representation of such a sensor is depicted in FIG. 2. In use, the test strip would be exposed to the test sample (e.g. a body of water, a patient's blood, a foodstuff, a drink, or an industrial or household waste sample).

A process for forming a sensor in accordance with another embodiment of the present invention will now be described. In this embodiment, redox active species are bound to gold nanoparticles that are bound to a protective layer surrounding a GC electrode.

GC electrodes are first modified with 4-aminophenyl to form a SAL (GC-Ph-NH₂). The terminal amine groups are then converted to diazonium groups by incubating the GC-Ph-NH₂ interface in a solution of NaNO₂ and HCl to form a 4-phenyl diazonium chloride modified interface (GC-Ph-N₂⁺Cl⁻). Subsequently, gold nanoparticles are immobilized on the interface by electrochemical reduction, via the formation of a stable C—Au bond to achieve a 4-phenyl gold nanoparticle modified interface (GC-Ph-AuNP). The GC-Ph-AuNP modified surface was then incubated with OEG to form the OEG modified GC surfaces (GC-Ph-AuNP/OEG).

The surfaces of the gold nanoparticles can be further functionalized and a redox active species covalently attached to the functionalised surface. The binding moiety can then be attached to the redox active species using the methods discussed above.

### EXAMPLES

### Reagents and Materials

HbA1c control samples of four levels of glycosylated hemoglobin were obtained from Kamiya Biomedical company (USA), and used without further purification. The lyophilized HbA1c samples are a hemolysate prepared from packed human erythrocytes, with stabilizers added to maintain hemoglobin in the reduced state for the accurate calibration of the HbA1c procedure. N-glycosylated pentapeptide (N-glycosylated-Val-His-Leu-Thr-Pro, purity by HPLC>97.5%) was purchased from Tocris bioscience (UK). Human HbA1c monoclonal antibody IgG (anti-HbA1c IgG) was supplied from Abnova (USA). The molecular wire was synthesized by following the methods from Tour and co-workers with some modifications. Oligo(ethylene glycol) was synthesized according to the method reported. Ferrocenedimethylamine was synthesized using the procedure from Ossola (Ossola, F., et al, Inorgan. Chim. Acta 2003, 353, 292-300). Reagent grade dipotassium orthophosphate, potassium dihydrogen orthophosphate, potassium chloride, sodium hydroxide, sodium chloride, sodium nitrite, hydrochloric acid, methanol and diethyl ether were purchased from Ajax Chemicals Pty Ltd. (Sydney, Australia). Potassium ferricyanide (K₄Fe(CN)₆), 1-ethyl-3-(3-dimethylaminopropyl) carbodiimide hydrochloride (EDC), N-hydroxysuccinimide (NHS), 1,3-dicyclohexylcarbodiimide (DCC), ferrocenecarboxaldehyde, sodium cyanoborohydride, dimethylsulfoxide (DMSO), hemoglobin, bovine serum albumin (BSA), anti-biotin IgG from goat, and absolute ethanol were obtained from Sigma-Aldrich (Sydney, Australia). All reagents were used as received, and aqueous solutions were prepared with purified water (18 MΩ cm⁻¹, Millipore, Sydney, Australia). Phosphate buffered saline (PBS) solutions were 0.137 M NaCl and 0.1 M K₂HPO₄/KH₂PO₄ and adjusted with NaOH or HCl solution to pH 7.3. Phosphate buffer solutions used in this work were 0.05 M KCl and 0.05 M K₂HPO₄/KH₂PO₄ and adjusted with NaOH or HCl solution to pH 7.0.

### Electrochemical Measurements

All electrochemical measurements were performed with a BAS-100B electrochemical analyser (Bioanalytical System Inc., USA) and a conventional three-electrode system. GC electrodes (Bioanalytical Systems Inc., USA) were prepared from 3 mm-diameter rods embodied into epoxy resin and were used as working electrode. Platinum foil and a Ag/AgCl (3.0 M NaCl) electrode were used as the counter and reference electrodes. All potential reported versus the Ag/AgCl reference electrode at room temperature. All cyclic voltammetry (CV) and square wave voltammetry (SWV) measurements were carried out in pH 7.0 phosphate buffer.

### Example 1

### Formation of Electrochemical Sensors

Modification of GC Electrodes with Molecular Wire (MW) or Single-Walled Carbon Nanotubes (SWCNTs) and Oligo Ethylene Glycol (OEG)

Commercial GC (glassy carbon) electrodes were hand-polished successively in 1.0, 0.3, and 0.05 μm alumina slurries made from dry Buehler alumina mixed with Milli-Q water (18 MΩ cm) on microcloth pads (Buehler, Lake Bluff, Ill., USA). The electrodes were thoroughly rinsed with Milli-Q water and sonicated in Milli-Q water for 2 min and then dried with an argon gas stream. Surface derivatization of the GC electrodes with MW/OEG mixed layers was achieved by electrochemical reduction of in situ-generated binary aryl diazonium cations of MW and OEG in aqueous solution. Specifically, a mixture of 5 mM molecular wire which was firstly dissolved in a minimum of DMSO, and OEG (the molar ratio of MW to OEG is 1:50) was solubilized in 0.5 M aqueous HCl, and 5 mM sodium nitrite were added to generate the aryl diazonium salts in the electrochemical cell (in situ), which would attach to the GC electrode surfaces immediately by scanning cyclic voltammetry between 0.6 V and −1.1 V for two cycles at the scan rate of 100 mV s-1.

To use single walled carbon nanotubes (SWCNTs) as the conduit for electron transfer instead of molecular wires, GC electrodes were modified with 4-nitrophenyl using an acetonitrile solution of 1 mM 4-nitrophenyl diazonium tetrafluoroborate and 0.1 M NaBu₄BF₄ using cyclic voltammetry (CV) with a scan rate of 100 mV s⁻¹ for two cycles between +1.0 V and −1.5 V. The diazonium salt solution was deaerated with argon for at least 15 min prior to derivatization. The obtained 4-nitrophenyl groups on GC electrodes could be reduced electrochemically to 4-aminophenyl groups in a protic solution (90:10 v/v H₂O-EtOH+0.1 M KCl). The modified electrodes were rinsed with copious amounts of acetonitrile and then water and dried under a stream of argon prior to immersion for 4 h in a DMF solution of cut SWCNTs (0.1 mg mL-1) with 0.5 mg mL-1 DCC at room temperature. Electrodes modified with carbon nanotubes via self-assembly in the manner described give nanotubes normal to the surface of diazonium salt modified carbon electrodes.

### Covalent Coupling of Ferrocenedimethylamine and Epitope to the Molecular Wire Molecules on the Modified GC Electrode

After modification with the MW/OEG layers, the GC electrode is ready for the fabrication of the sensing interface. This involves the step of attachment of ferrocenedimethylamine (FDMA) followed by N-glycosylated pentapeptide (GPP). Covalent attachment of FDMA to the carboxylic acid terminated MW/OEG mixed layers was achieved by incubating the MW/OEG modified GC electrodes into absolute ethanol containing of 40 mM DCC and 5 mM FDMA for 6 h at room temperature. Any nonspecific adsorption of FDMA was removed by sonication in Milli-Q water for 2 min or continuous cycling between 0 V and 0.8 V in phosphate buffer until obtaining the stable electrochemistry.

To the remaining free amine of FDMA the GPP was attached using classical carbodiimide coupling. Note with the glycosylation of the peptide at its N-terminus (FIG. 1) there is no free amine, and only one carboxyl, on the peptide such that the only one coupling reaction can occur and hence a well-defined sensing interface is achieved. After attachment of FDMA, the GC electrode surfaces covered with amine terminal groups were immersed into 2 mM solution of GPP in phosphate buffered pH 6.8 containing 20 mM EDC and 10 mM NHS for 4 h at 4° C. to attach the glycosylated pentapeptide to the free terminal amines on the surface bound FDMA.

Then GPP terminated surface was subsequently incubated in 250 ng mL⁻¹ human HbA1c monoclonal antibody IgG solution for 3 h at 4° C.

### Electrochemistry of the Electrode

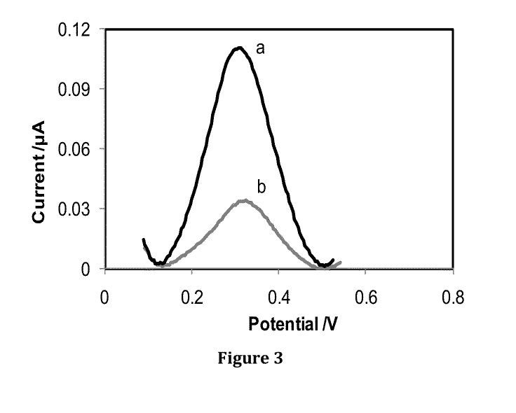

As can be seen in FIG. 3, after the attachment of GPP, the electrochemistry of the FDMA modified GC electrode surfaces showed only a minor change in peak currents. This is an encouraging result as it indicates the peptide does not block the surface electrochemistry, a necessary condition for the sensor to be able to operate.

Complexation of the human anti-HbA1c monoclonal IgG with the GPP attached to the end of the MW results in an obvious attenuation of the ferrocene electrochemistry (FIG. 3). In this case the anti-HbA1c IgG binding to the sensing interface results in the FDMA electrochemistry being reduced by 67%±4% (95% confidence, n=6) of the value prior to exposure to the anti-HbA1c IgG.

Three controls were performed to verify that the change in current was, indeed, due to a specific interaction between the anti-HbA1c IgG and the surface bound GPP epitope. These were:

1) if the GPP was not coupled to the end of the MW because the surface carboxyl was not activated with EDC/NHS, followed by the incubation with 250 ng mL⁻¹ anti-HbA1c IgG. In this case there was only a very minor decrease in current indicating the epitope was required for the current suppression.
2) If the full sensing interface was fabricated but the anti-HbA1c IgG was precomplexed with 2 mM GPP for 3 h at 4° C., such that the antibody had no available binding sites to complex with the surface no significant attenuation in current was observed; and
3) the biosensing was incubated in either the wrong IgG, in this case 10 μg mL⁻¹ anti-biotin IgG, or another protein completely, so 10 μg mL⁻¹ bovine serum albumin. Again only very minor decreases in electrochemistry (5% of SWV current reduction) were observed.
Modification of GC Electrodes with Protective Layer and Gold Nanoparticles

GC electrodes were purchased as 3-mm-diameter disks from Bioanalytical Systems Inc., USA. The electrodes were polished successively with 1.0, 0.3, and 0.05 μm alumina slurries made from dry Buehler alumina and Milli-Q water on microcloth pads (Buehler, Lake Bluff, Ill., USA). The electrodes were thoroughly rinsed with Milli-Q water and sonicated in Milli-Q water for 2 min after polishing. Before derivatization, the electrodes were dried under an argon gas stream.

The GC electrodes are first modified with 4-aminoaniline to produce surface bound 4-aminophenyl groups (GC-Ph-NH₂) via reductive adsorption of the 4-aminoaniline in the presence of sodium nitrite and HCl. Once the SAL is formed, the terminal amine groups are converted to diazonium groups by incubating the GC-Ph-NH₂ interface in NaNO₂ and HCl solution to form a 4-phenyl diazonium chloride modified interface (GC-Ph-N₂⁺Cl⁻). Subsequently AuNP are immobilized on the interface by electrochemical reduction and the formation of a stable C—Au bond to achieve a 4-phenyl AuNP modified interface (GC-Ph-AuNP). Then GC-Ph-AuNP modified surface was incubated in absolute ethanol solution containing 10 mM OEG and 40 mM DCC for 6 h at the room temperature to form the OEG modified GC surfaces (GC-Ph-AuNP/OEG). Subsequently surfaces attached AuNP can be further functionalized with 4-carboxyphenyl by scanning potential between 0.5 V and −0.5 V at 0.5 M HCl solution containing 1 mM NaNO₂ and 1 mM 4-aminobenzoic acid for two cycles at the scan rate of 100 mV s⁻¹ to form GC-Ph-AuNP/OEG/Ph-CP surfaces. Covalent attachment of FDMA to the carboxylic acid terminated surfaces was achieved by incubating the GC-Ph-AuNP/OEG/Ph-CP surfaces into absolute ethanol containing of 40 mM DCC and 5 mM FDMA for 6 h at room temperature. Any nonspecific adsorption of FDMA was removed by sonication in Milli-Q water for 2 min or continuous cycling between 0 V and 0.8 V in phosphate buffer until obtaining the stable electrochemistry. After attachment of FDMA, the GC electrode surfaces covered with amine terminal groups were immersed into 2 mM solution of GPP in phosphate buffered pH 6.8 containing of 20 mM EDC and 10 mM NHS for 4 h at 4° C. to attach GPP to form GC-Ph-AuNP/OEG/Ph-CP/FDMA/GPP surfaces. Then GPP terminated surface can be used as the sensing interfaces of the competitive inhibition assay for the detection of HbA1c in human blood. Higher concentrations of analytes in the serum mean that less anti-HbA1c IgG binds to the surface, and a higher current is observed.

### Example 2

### Competitive Inhibition Assay for Detecting HbA1c in a Sample

As a consequence of the anti-HbA1c IgG selectively binding to the sensing interface, a competitive inhibition assay (FIG. 1) was developed to detect the amount of HbA1c in serum.

In the competitive inhibition assay, the final biosensing interface is the FDMA and GPP attached to the MW, as described in Example 1 (with no anti-HbA1c IgG).

The anti-HbA1c IgG is introduced into the sample solution, where it will complex with any analyte (i.e. HbA1c) present. Any remaining uncomplexed anti-HbA1c IgG is then free to bind to the biosensing interface (i.e. via the GPP epitope), which attenuates the FDMA electrochemistry. Hence the greater the amount of analyte, the more anti-HbA1c IgG complexes with the analyte, the lower the amount of free anti-HbA1c IgG to bind to the biosensing interface and thus the higher the electrochemical signal.

To first show the competitive inhibition assay is viable in such a complex matrix as serum, the sensing interface was incubated with the solution containing 2 μg mL⁻¹ anti-HbA1c IgG containing 13.5% HbA1c in serum. This caused some current attenuation, suggesting there is free antibody in solution that has not complexed with the HbA1c in solution, and hence can bind to the sensing interface. It was observed that the current decreased by about 29% in this case, which is a significantly lower current attenuation compared with the current decreased after exposure GPP modified interface to anti-HbA1c IgG where there is no analyte (HbA1c) present (67%).

In a second control experiment, the sensing interface was exposed to anti-HbA1c IgG first incubated with 2 mM pentapeptide VHLTP (peptide that was not glycosylated) or haemoglobin, such that all anti-HbA1c IgG should be available to bind to the surface, the current was attenuated to a similar extent to when the sensor was incubated in just anti-HbA1c IgG.

These two control experiments demonstrate that the lower current attenuation when the biosensor is exposed to anti-HbA1c IgG containing HbA1c in serum samples, compared with when just exposed to a sample of anti-HbA1c IgG, is due to HbA1c binding to the anti-HbA1c IgG. Thus the magnitude of current decrease is expected to be different if the anti-HbA1c IgG is mixed with HbA1c with different concentration.

A calibration curve can be obtained in the following manner. HbA1c standards having a percentage HbA1c of 4.5%, 8%, 12.1% and 15.1%, but with the same total concentration of haemoglobin (glycosylated and non-glycosylated), were used as received. Note these HbA1c standards are prepared in serum. Samples with other HbA1c levels were prepared by mixing control sample R1 (4.5%) and control sample R4 (15.1%) with stock solutions in different ratios. The calibration curve was plotted and covered the expected clinical range of HbA1c to haemoglobin levels, and shows that the relative current is linear with the HbA1c % of total haemoglobin in the range of 4.5%-15.1%.

The results show that in the competitive inhibition assay for the detection of HbA1c in serum a good linear relationship between the relative current and the concentration of HbA1c was observed.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that a reference herein to a prior art publication does not constitute an admission that the publication forms a part of the common general knowledge in the art, in Australia or in any other country.

1. A method for detecting the presence of an analyte in a sample, the method comprising the steps of:
adding to the sample an antibody of the analyte;
exposing to the sample a binding moiety capable of associating with the antibody of the analyte, the binding moiety being associated with a redox active species that is bound to an electrode and electrochemically accessible to the electrode; and
taking amperometric electrochemical measurements which indicate whether the electrochemistry of the redox active species has been modulated by the binding moiety associating with the antibody of the analyte.

2. The method as claimed in claim 1, wherein the electrochemical measurements are taken at the time the binding moiety is exposed to the sample, and wherein the electrochemical measurements are used to quantify the amount of the antibody of the analyte which associates with the binding moiety.

3. The method as claimed in claim 1, wherein the analyte is HbA1c, and wherein the binding moiety comprises an epitope for an antibody of HbA1c.

4. The method as claimed in claim 3, wherein the binding moiety comprises N-glycosylated-Val-His-Leu-Thr-Pro.

5. The method as claimed in claim 3, when used to determine blood glucose levels of a patient over an extended period of time.

6. A method for determining blood glucose levels in a patient, the method comprising the steps of:
adding to a sample of the patient's blood an antibody of HbA1c;
exposing to the sample a binding moiety capable of associating with the antibody of Hb1Ac, the binding moiety being associated with a redox active species that is bound to an electrode and electrochemically accessible to the electrode; and
taking amperometric electrochemical measurements which indicate whether the electrochemistry of the redox active species has been modulated by the binding moiety associating with the antibody of HbA1c.

7. The method as claimed in claim 6, wherein the electrochemical measurements are used to quantify the amount of the antibody of HbA1c which associates with the binding moiety.

8. The method as claimed in claim 7, comprising the further step of calculating the amount of HbA1c in the sample based on the amount of the antibody of HbA1c which associates with the binding moiety.

9. The method as claimed in claim 6, wherein the method is repeated at predetermined time intervals in order to determine the patient's blood glucose levels over time.

10. An amperometric electrochemical sensor for detecting an analyte, the sensor comprising:
an electrode;
a redox active species that is electrochemically accessible to the electrode; and
a binding moiety capable of associating with an antibody of the analyte;
whereby association of the binding moiety with the antibody of the analyte affects the electrochemistry of the redox active species.

11. The sensor as claimed in claim 10, wherein the binding moiety comprises an epitope for the antibody of the analyte.

12. The sensor as claimed in claim 10, wherein the binding moiety is bound to the redox active species, and wherein the redox active species is bound to the electrode.

13. The sensor as claimed in claim 12, wherein the redox active species is bound to the electrode by a species that is a conduit for electron movement, and wherein the species that is a conduit for electron movement is a molecular wire or a nanotube.

14. The sensor as claimed in claim 10, which further comprises blocking agents bound to the electrode.

15. The sensor as claimed in claim 10, wherein the redox active species is bound to a conductive nanoparticle that is bound to a protective layer covering the electrode, and wherein the conductive nanoparticle is a metallic nanoparticle.

16. The sensor as claimed in claim 15, wherein the protective layer is a self-assembled layer comprising molecules of oligo(ethylene glycol) or 4-thiophenyl.

17. The sensor as claimed in claim 10, further comprising a detector capable of detecting changes in the electrochemistry of the redox active species as a result of the association of the binding moiety with the analyte, an electrical power source and a display for displaying electrochemical readings from the electrode.

18. The sensor as claimed in claim 10, wherein the analyte is HbA1c, and wherein the binding moiety comprises an epitope for an antibody of HbA1c.

19. A kit for detecting the presence of an analyte in a sample, the kit comprising an electrochemical sensor of claim 10 and a container comprising an antibody of the analyte.

20. A method for detecting the presence of an analyte in a sample, the method comprising the steps of:
adding to the sample an antibody of the analyte;
exposing to the sample the electrochemical sensor of claim 10; and
taking amperometric electrochemical measurements which indicate whether the electrochemistry of the redox active species has been modulated by the binding moiety associating with the antibody of the analyte.
